(19) United States
(12) Patent Application Publication
(10) Pub. No.: US 2021/0206017 A1
(43) Pub. Date: Jul. 8, 2021

(54) LOCK NUT BLADE ASSEMBLY

(71) Applicant: Lenexa Manufacturing Company, LLC, Lenexa, KS (US)

(72) Inventors: Stephen E. Bastasch, Fairway, KS (US); Anthony L. Dailey, Grandview, MO (US); Jason C. Secrest, Olathe, KS (US)

(21) Appl. No.: 17/128,756

(22) Filed: Dec. 21, 2020

Related U.S. Application Data
(60) Provisional application No. 62/957,008, filed on Jan. 3, 2020.

(51) Int. Cl. B27B 5/32

(52) U.S. Cl. CPC B27B 5/32

(57) ABSTRACT

A lock nut blade assembly includes a shaft mounting a circular blade via a lock nut hub subassembly in an assembled configuration. The blade assembly is particularly configured for multi-blade slicers in production lines for sliced bread products such as buns, rolls, bagels, hoagies and chibatas. The blade assembly can be easily disassembled with hand tools for replacing worn and dull blades, while retaining other blade assembly components for continued service.

### CROSS-REFERENCE TO RELATED APPLICATION

This application claims priority in U.S. Provisional Patent Application No. 62/957,008 filed Jan. 3, 2020, which is incorporated herein by reference.

### BACKGROUND OF THE INVENTION

### 1. Field of the Invention

The present invention relates generally to blade assemblies, and in particular to a blade assembly for automatic slicing machines for baked food products, such as buns and bagels. The blade assembly can be easily disassembled and reassembled for blade replacement.

### 2. Description of the Related Art

Automated bakery production lines for sliced food products, such as buns, rolls, bagels, hoagies, ciabattas, etc., commonly include slicers with multiple blade assemblies. The blade assemblies are generally installed side-by-side in gang configurations in commercial slicers, and are driven by electric motors (prime movers) via drive belts for synchronized slicing operations. Product slicing is typically the last production step in a production line prior to packaging and bagging for shipment. Blade maintenance generally involves replacing the blade assemblies as they become dull or damaged. However, replacing a single blade assembly can shut down an entire production line at significant expense in lost production. Moreover, the sawtooth cutting blade is often the only blade assembly wear component requiring replacement.

The food products can be conveyed along the production lines through the slicing equipment. The saw blades in such equipment are wear items requiring resharpening or replacement as they dull. Current practice typically involves replacing the complete blade assemblies, even though the only parts subjected to significant wear are the actual blade teeth. The present invention enables more cost-effective bakery operations by providing blade assemblies which can be easily disassembled and reassembled with replacement blades, while retaining other parts of the assemblies. The worn blades can be re-sharpened or otherwise recycled.

Heretofore there has not been available a lock nut blade assembly with the advantages and features of the present invention.

### BRIEF DESCRIPTION OF THE DRAWINGS

The drawings constitute a part of this specification and include exemplary embodiments of the present invention illustrating various objects and features thereof.

FIG. 1 is an upper perspective view of a lock nut blade assembly embodying a preferred aspect or embodiment of the present invention.

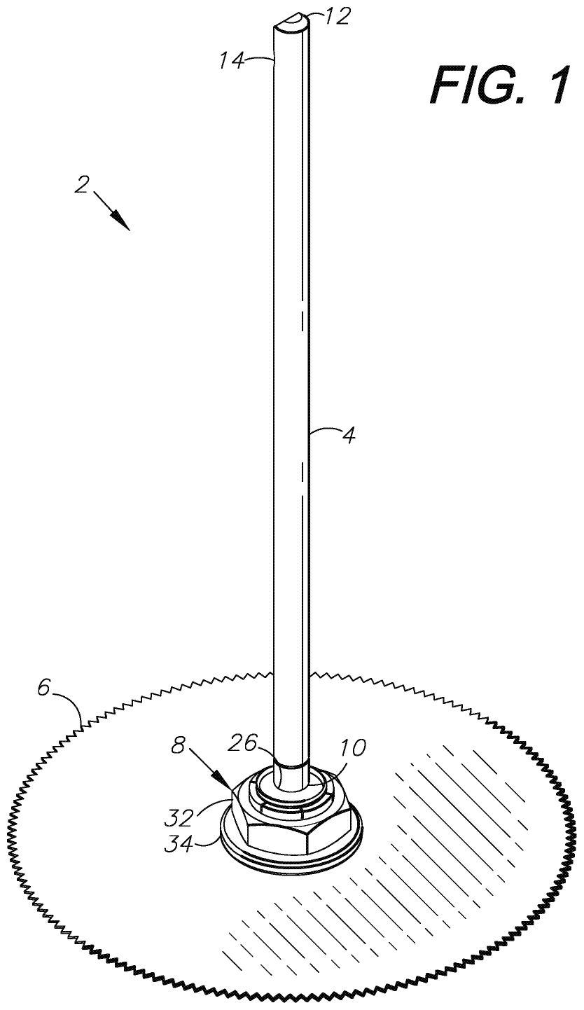

FIG. 2 is a side elevational view of the blade assembly.

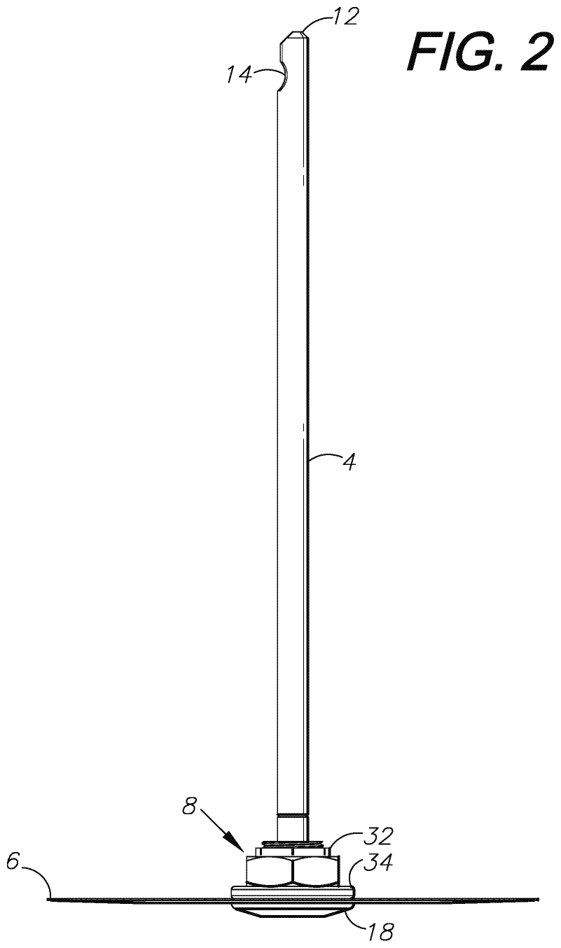

FIG. 3a is an upper, perspective, fragmentary view of the blade assembly, particularly showing a lock nut hub subassembly in its unassembled configuration with a blade in a dismounted position.

FIG. 3b is an upper, perspective, fragmentary view of the blade assembly, particularly showing the lock nut hub subassembly unassembled and the blade in its mounted position.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

### II. Lock Nut Blade Assembly 2

Referring to the drawings more detail, the reference numeral 2 generally designates a lock nut blade assembly, which includes a blade shaft 4 mounting a blade 6 with a lock nut hub subassembly 8. Without limitation, the lock nut blade assembly 2 can be installed on food product slicing equipment, particularly bread product slicers.

The blade shaft 4 includes first (upper) and second (lower) ends 10, 12, and defines a generally vertical rotational axis for the blade assembly 2. Upper, lower and similar terms are in reference to the drawings. Without limitation, blade assemblies within the scope of the present invention can be installed and operated in various other orientations. For example, the rotational axis can extend horizontally. The shaft upper end 10 includes a notch 14 for fixedly mounting a driven sprocket in a chain-and-sprocket drive system connected to a prime mover, such as an electric motor (not shown). Other drive systems can be utilized with the present invention, such as belt-and-pulley systems, driveshaft-and-gear systems, etc.

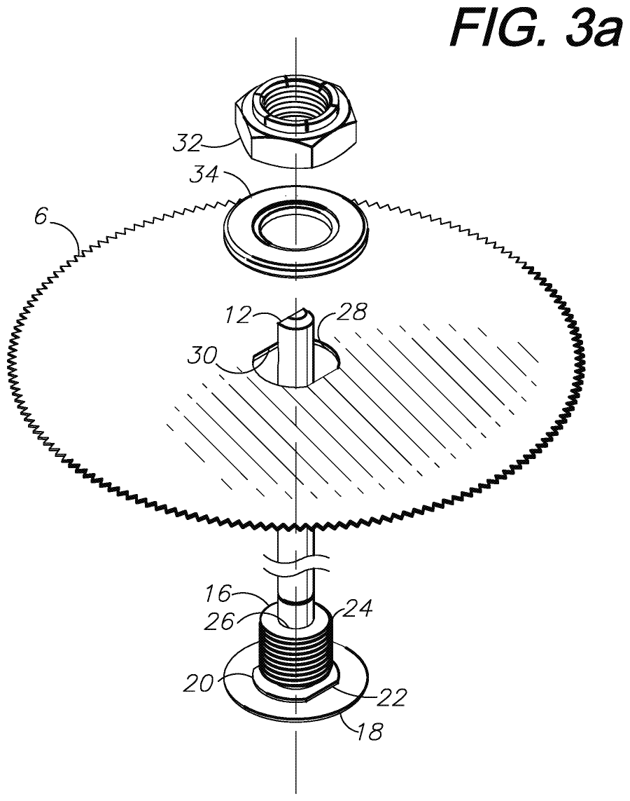

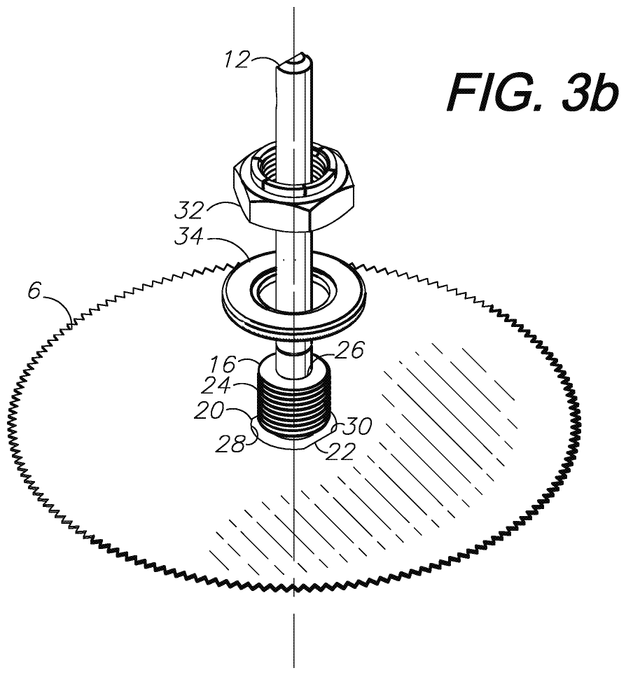

The lock nut hub subassembly 8 includes a hub 16 with a lower, flanged hub head 18. A lock extension 20 protrudes upwardly from the head 18 and includes a pair of engagement flats 22 on opposite sides of the head 18. The hub upper end forms a cylindrical male-threaded section 24 with a receiver 26 receiving the shaft lower end 12 in a press-fit connection. As shown in FIGS. 3a, 3b, the blade 6 includes a cutout or opening 28 with a pair of blade engagement flats 30 configured for engaging the hub engagement flats 22 and aligning the blade on the hub 16 in a fixed, non-rotating engagement whereby the blade 6 is rotated by the shaft 4. The lock nut hub subassembly 8 also includes a female-threaded lock nut 32 threadably received on the male-threaded section 24. A washer 34 receives the threaded section 24 and is clamped with the blade 6 between the head 18 and the lock nut 32.

### III. Operation

In operation, the blade assembly 2 is configured for enhancing bakery operation generally and slicer operation specifically by minimizing costs and downtime for slicer maintenance, particularly blade replacements. Such replacements are routine maintenance tasks as the blade teeth become dull. Dull blades require greater rotational energy to operate. They also increase the “crumbage,” comprising bread particles produced as the bread products are sawn and sliced. Efficient, cost-effective bakery production line operation can thus be enhanced by routine blade-replacement, maintenance. With the product slicing equipment stopped, the gangs of blade assemblies 2 can be lifted to disengaged, maintenance positions.

Blade replacement can be accomplished by unscrewing the lock nut 32 and removing the worn, dull blade 6. A replacement blade 6 is placed onto the shaft 4 and the hub 16 engagement flats 22 are aligned with the corresponding engagement flats 30 of the blade cutout 28. The lock nut 32 is retightened to securely clamp the replacement blade 6 between the flanged head 18 and the washer 34. The rebuilt blade assembly 2 is checked for runout within tolerances and then reinstalled on the slicing equipment.

Optionally, the individual blade assemblies 2 can be extracted from the equipment for immediate replacement and later rebuilding with replacement blades, shafts, etc. For example, if a blade assembly 2 only requires blade replacement, considerable expense can be saved, as compared to replacing an entire blade assembly. Maintenance may also involve checking the other blade assembly components for damage and wear, such as checking blade runout and checking the shafts 4 for straightness. Components are designed for minimizing operating expenses by enabling replacement of wear parts, such as the blades, while retaining other parts for continued service. Moreover, bent shafts and other damaged parts can easily and quickly be replaced. Operators can maintain inventories of spare parts for needed replacements without delays for ordering, shipping, handling, etc.

The invention is adaptable to various applications involving multi-part assemblies, particularly those susceptible to damage and wear. Part replacement and other servicing procedures can generally be accomplished with basic tools and minimal service personnel training.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A lock nut blade assembly for a motorized saw, which blade assembly includes:
a shaft with first and second ends;
said shaft first end drivingly connected to a motor;
a circular saw blade including a circumferential cutting edge with saw teeth and a center cutout;
a lock nut hub subassembly configured for mounting said blade on said shaft second end; and
said blade assembly having an assembled configuration with said blade mounted on said shaft second end and a disassembled configuration with said blade removed from said shaft second end.

2. The blade assembly of claim 1 wherein said lock nut hub subassembly includes a hub receiving said shaft second end.

3. The blade assembly of claim 2 wherein said lock nut hub subassembly includes a flanged head mounted on said hub and including a locking extension configured for placement in said blade cutout with said blade assembly in its assembled configuration.

4. The blade assembly of claim 3 wherein said lock nut hub subassembly includes:
a male-threaded section extending from said locking extension; and
a female-threaded nut configured for threadably receiving said male-threaded section; and
said nut configured for clamping said blade on said lock nut hub subassembly with said blade assembly in its assembled configuration.

5. The blade assembly of claim 4, which includes
a male-threaded section extending from said locking extension; and a female-threaded nut threadably receiving said male-threaded section.

6. The blade assembly of claim 5, which includes:
said blade cutout having a blade engagement flat;
said hub locking extension having a hub engagement flat; and
said engagement flats abutting each other in a fixed, anti-rotation relation when said blade is mounted on said hub subassembly with said blade assembly in its assembled configuration.

7. The blade assembly of claim 5, which includes:
said nut comprising a lock nut; and
a washer receiving said threaded extension and clamping said blade on said flanged head with said extension and said cutout and said blade assembly in its assembled configuration.

8. The blade assembly of claim 1 wherein said motorized saw comprises a food product saw.

9. The blade assembly of claim 1 wherein said motorized saw includes multiple blade assemblies in a gang configuration in a production line.

10. A lock nut blade assembly for a motorized food product saw, which blade assembly includes:
a shaft with first and second ends;
said shaft first end drivingly connected to a motor;
a circular saw blade including a circumferential cutting edge with saw teeth and a center cutout;
a lock nut hub subassembly configured for mounting said blade on said shaft second end, said lock nut hub subassembly including a hub receiving said shaft second end;
said blade assembly having an assembled configuration with said blade mounted on said shaft second end and a disassembled configuration with said blade removed from said shaft second end;
said lock nut hub subassembly including a flanged head mounted on said hub and including a locking extension configured for placement in said blade cutout with said blade assembly in its assembled configuration;
said lock nut hub subassembly including: a male-threaded section extending from said locking extension; a female-threaded lock nut configured for threadably receiving said male-threaded section, said nut configured for clamping said blade on said lock nut hub assembly with said blade assembly in its assembled configuration; a male-threaded section extending from said locking extension; and a female-threaded nut threadably receiving said male-threaded section;
said blade cutout having a blade engagement flat;
said hub locking extension having a hub engagement flat;
said engagement flats abutting each other in a fixed, anti-rotation relation when said blade is mounted on said hub subassembly with said blade assembly in its assembled configuration; and
a washer receiving said threaded extension and clamping said blade on said flanged head with said extension and said cutout and said blade assembly in its assembled configuration.

11. The blade assembly of claim 10 wherein said motorized saw includes multiple blade assemblies in a gang configuration in a production line.
